(19) United States
(12) Patent Application Publication
(10) Pub. No.: US 2014/0075038 A1
(43) Pub. Date: Mar. 13, 2014

(54) COMMUNICATION DEVICE, COMPUTER-READABLE STORAGE MEDIUM, AND COMMUNICATION SYSTEM

(71) Applicant: Oki Electric Industry Co., Ltd., Tokyo (JP)

(72) Inventor: Kei Kato, Tokyo (JP)

(21) Appl. No.: 13/977,627

(22) PCT Filed: Apr. 18, 2013
(86) PCT No.: PCT/JP2013/061537

§ 371 Date: Jun. 28, 2013

(30) Foreign Application Priority Data
Sep. 13, 2012 (JP) 2012-201671

(51) Int. Cl. H04L 29/06

(52) U.S. Cl. CPC H04L 65/1006
USPC 709/228

(57) ABSTRACT

Provided is a communication system that performs effective media data communication while preventing deterioration in communication quality. The present invention relates to a communication device that relays data between plural networks. The communication device includes a data processing unit for transmitting received data to a route to a destination of the data, a unit for managing data flowing through the communication device in a session unit and classifying managed sessions into a management session and a non-management session, and a unit for determining a route related to the management session based on conditions of the non-management session passing through each route. The data processing unit outputs data related to the management session to the route.

### TECHNICAL FIELD

The present invention relates to a communication device, a program, and a communication system and can be applied to, for example, a network which transmits media data, such as data, audio, and video.

### BACKGROUND ART

In an IP network (for example, a communication carrier network) corresponding to media communication, such as telephone communication, in the related art, a structure has come into widespread use in which session control (call control) is performed by an SIP (Session Initiation Protocol; see Non-patent Literature 1 (IETF RFC3261)) and an SDP (Session Description Protocol).

In general, in the session control using the SIP, a session is established and managed for each medium, such as audio or video, during connection.

### SUMMARY OF INVENTION

### Technical Problem

However, in the IP network, such as a communication carrier network, corresponding to the telephone communication, there is traffic which is not controlled by the SIP. For example, in some cases, the session which is not controlled by the SIP is maintained for a long time (for example, 10 minutes or more) between a moving picture distribution server which distributes a video (moving picture) and a terminal which receives a video.

In addition, a large amount of traffic is likely to flow through a path in which the session of a high-capacity medium is established for a long time in a burst manner, as in the distribution of image data streams or the download of a high-capacity data file. When there is a real-time session which is controlled by the SIP in the same path as in telephone communication, the communication of the session is likely to be pressed and affected.

### Solution to Problem

The invention has been made in view of the above-mentioned problems and an object of the invention is to provide a communication device, a program, and a communication system capable of performing effective media data communication while preventing deterioration in communication quality.

According to a first aspect of the invention, there is provided a communication device that relays data among plural networks. The communication device includes (1) a data processing unit for transmitting received data to a route to a destination of the data, (2) a session management unit for managing data flowing through the communication device in a session unit and classifying managed sessions into a management session which is managed by a call control device using a call control protocol and a non-management session which is not managed by the call control device using the call control protocol, and (3) a route determining unit for determining a route related to the management session which is managed by the session management unit based on conditions of the non-management session passing through a route to a destination of the management session. (4) The data processing unit outputs data related to the management session to the route determined by the route determining unit.

According to a second aspect of the invention, there is provided a communication program that causes (1) a computer provided in a communication device which relays data among plural networks to function as (2) a data processing unit for transmitting received data to a route to a destination of the data, (3) a session management unit for managing data flowing through the communication device in a session unit and classifying managed sessions into a management session which is managed by a call control device using a call control protocol and a non-management session which is not managed by the call control device using the call control protocol, and (4) a route determining unit for determining a route related to the management session which is managed by the session management unit based on conditions of the non-management session passing through a route to a destination of the management session. (5) The data processing unit outputs data related to the management session to the route determined by the route determining unit.

According to a third aspect of the invention, there is provided a communication method that causes (1) a computer provided in a communication device which relays data among plural networks to perform (2) transmitting received data to a route to a destination of the data, (3) managing data flowing through the communication device in a session unit and classifying managed sessions into a management session which is managed by a call control device using a call control protocol and a non-management session which is not managed by the call control device using the call control protocol, and (4) determining a route related to the management session based on conditions of the non-management session passing through a route to a destination of the management session. (5) In the transmission of the received data, data related to the management session is transmitted to the determined route.

According to a fourth aspect of the invention, a communication system includes the communication device according to the first aspect that relays the data among the plural networks.

### Advantageous Effects of Invention

According to the invention, it is possible to provide a communication system capable of performing effective media data communication while preventing deterioration in communication quality.

### BRIEF DESCRIPTION OF DRAWINGS

FIG. 1 is a block diagram illustrating the overall structure of a communication system according to an embodiment.

FIG. 2 is a block diagram illustrating the functional structure of a communication device according to the embodiment.

FIG. 3 is a diagram illustrating an example of the structure of a session management table according to the embodiment.

FIG. 4A is a diagram illustrating an example of the structure of a route management table according to the embodiment.

FIG. 4B is a diagram illustrating an example of the structure of the route management table according to the embodiment.

FIG. 5 is a diagram illustrating an example of a header of an SIP message processed by a communication processing unit according to the embodiment.

FIG. 6 is a flowchart illustrating the operation of the communication system according to the embodiment when a non-SIP managed session is generated.

FIG. 7 is a diagram (part 1) illustrating a transition in the session management table according to the embodiment.

FIG. 8A is a diagram (part 1) illustrating a transition in the route management table according to the embodiment.

FIG. 8B is a diagram (part 1) illustrating a transition in the route management table according to the embodiment.

FIG. 9 is a diagram (part 2) illustrating a transition in the session management table according to the embodiment.

FIG. 10 is a diagram (part 3) illustrating a transition in the session management table according to the embodiment.

FIG. 11A is a diagram (part 2) illustrating a transition in the route management table according to the embodiment.

FIG. 11B is a diagram (part 2) illustrating a transition in the route management table according to the embodiment.

FIG. 12 is a flowchart illustrating the operation of the communication system according to the embodiment when an SIP managed session is generated.

FIG. 13 is a diagram (part 4) illustrating a transition in the session management table according to the embodiment.

FIG. 14 is a diagram (part 5) illustrating a transition in the session management table according to the embodiment.

FIG. 15A is a diagram (part 3) illustrating a transition in the route management table according to the embodiment.

FIG. 15B is a diagram (part 3) illustrating a transition in the route management table according to the embodiment.

### DESCRIPTION OF EMBODIMENTS

### (A) Main Embodiment

Hereinafter, a communication device, a program, and a communication system according to an embodiment of the invention will be described in detail with reference to the accompanying drawings. In the embodiment, an example in which the communication device according to the invention is applied to an SBC (Session Border Controller) will be described.

### (A-1) Structure of Embodiment

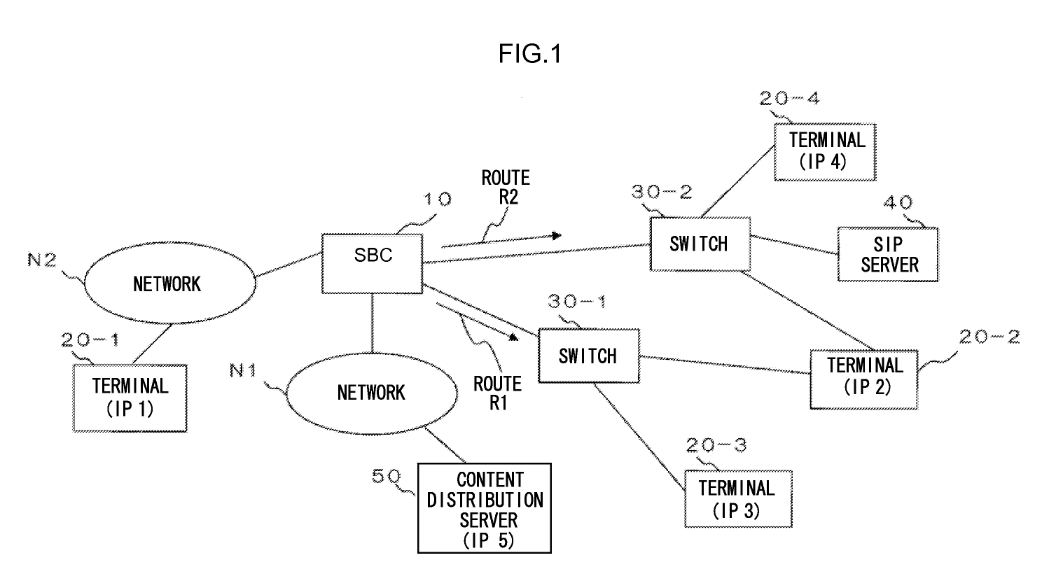

FIG. 1 is a block diagram illustrating the overall structure of a communication system 1 according to this embodiment.

The communication system 1 includes at least an SBC 10, four terminals 20 (20-1 to 20-4), two SWs 30 (30-1 and 30-2), an SIP server 40 which is a call control device, and a content distribution server 50.

FIG. 1 illustrates an example of the simplest structure in the description of the functions of the SBC 10 according to the invention. Therefore, the devices illustrated in FIG. 1 may be directly connected to each other, or they may communicate with each other through another communication device (for example, a switch or a router). In addition, the number of devices illustrated in FIG. 1 is not particularly limited.

The SBC 10 is a device which controls communication among networks (mainly the transmission of IP packets among the networks). As illustrated in FIG. 1, the SBC 10 is connected to at least networks N1 and N2, the switch 30-1, and the switch 30-2.

The switches 30-1 and 30-2 are layer 3 switches connected to the SBC 10. As illustrated in FIG. 1, hereinafter, a route from the SBC 10 to the switch 30-1 is referred to as a ‘route R1’. In addition, hereinafter, a route from the SBC 10 to the switch 30-2 is referred to as a ‘route R2’.

The SIP server 40 is a device (call control device) which functions as a call agent for performing call control between the terminals corresponding to an SIP using the SIP and an SDP. In FIG. 1, the SIP server 40 is connected to the end through the switch 30-2, as viewed from the SBC 10. In FIG. 1, it is assumed that the SIP server 40 performs call control at least between the terminal 20-1 and the terminal 20-2. For example, since a call agent corresponding to the existing SIP and SDP can be applied to the SIP server 40, the detailed description of the SIP server 40 will be omitted. In the communication system 1, a structure which performs call control is not particularly limited, but a call control process may be distributed and processed using plural SIP servers.

The terminal 20-1 and the terminal 20-2 correspond to the SIP and the SDP and can perform communication for a voice call or a video call. For example, since the existing PC, smart phone, IP telephone device, and conference terminal can be applied as the terminal 20-1 and the terminal 20-2, the detailed description of the terminals 20-1 and 20-2 will be omitted. In FIG. 1, it is assumed that the session (call) of the terminal 20-1 and the terminal 20-2 is established based on the call control (call control by an SIP message) of the SIP server 40.

As illustrated in FIG. 1, it is assumed that the terminal 20-2 is arranged at a position where it can be connected to the end through the switch 30-1 or the switch 30-2, as viewed from the SBC 10. In addition, it is assumed that the terminal 20-1 is connected to the network N2.

The content distribution server 50 performs content data distribution, such as the distribution of image data streams, the distribution of audio data streams, and the transmission of data files (for example, image data, text files, and programs), in response to a request from the terminal (receiving terminal). For example, when an image data stream or an audio data stream is distributed to the terminal, the content distribution server 50 transmits a data stream, such as a MPEG data stream, according to a transmission protocol, such as RTP/RTCP (Real-time Transport Protocol/RTP Control Protocol). For example, when a data file is transmitted to the terminal, the content distribution server 50 transmits the data file according to a protocol such as FTP or HTTP. Since the existing various content distribution servers can be applied as the content distribution server 50, the detailed description of the content distribution server 50 will be omitted. In this embodiment, it is assumed that the content distribution server 50 can distribute data for various kinds of content to at least the terminals 20-3 and 20-4. In this embodiment, it is assumed that, for the session related to the transmission of data from the content distribution server 50, the SIP is not used for communication control. In addition, it is assumed that the content distribution server 50 is connected to the network N1.

The terminals 20-3 and 20-4 are terminals (for example, smart phones or PCs) which can request the content distribution server 50 to distribute data for content and receive the data. As illustrated in FIG. 1, it is assumed that the terminal 20-3 is arranged at the end through the switch 30-1, as viewed from the SBC 10. In addition, as illustrated in FIG. 1, it is assumed that the terminal 20-4 is arranged at the end through the switch 30-2, as viewed from the SBC 10.

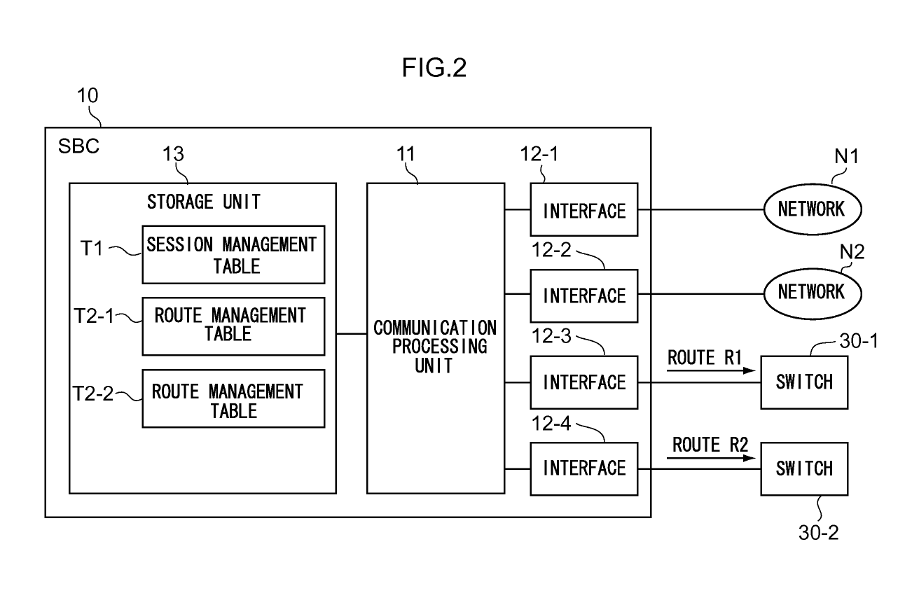

Next, the internal structure of the SBC 10 will be described with reference to FIG. 2.

The SBC 10 includes a communication processing unit 11, interfaces 12 (12-1 to 12-4), and a storage unit 13.

In the SBC 10, for example, a computer including a processor and a memory may execute a communication program according to this embodiment to implement the function of a component which processes packets (data) (for example, a component including the communication processing unit 11 and the storage unit 13). In this case, the functional structure of the SBC 10 may be as illustrated in FIG. 2.

The interfaces 12-1 to 12-4 are network interfaces of the SBC 10. For example, various Ethernet (registered trademark) interfaces can be applied as the interfaces 12-1 to 12-4. As illustrated in FIG. 1, the interface 12-1 is connected to the network N1 (a network device forming the network N1). The interface 12-2 is connected to the network N2 (a network device forming the network N2). The interface 12-3 is connected to the switch 30-1 (the network including the switch 30-1). The interface 12-4 is connected to the switch 30-2 (the network including the switch 30-2).

The number of interfaces provided in the SBC 10 or the type of the interface is not particularly limited. However, in this embodiment, it is assumed that the SBC 10 includes at least the above-mentioned four interfaces 12-1 to 12-4.

The communication processing unit 11 performs a process (routing process) of processing the packets received by each interface 12 and transmitting the processed packets to the next transmission destination (next hop) corresponding to the destination. The communication processing unit 11 performs the routing process for each packet in a basic session unit. The routing process performed by the communication processing unit 11 will be described in detail below.

The communication processing unit 11 analyzes the packets received by each interface 12 and applies the analysis result to each table stored in the storage unit 13.

The storage unit 13 is a storage means which stores data, such as each table used by the communication processing unit 11. In this embodiment, the storage unit 13 stores at least a session management table T1 and route management tables T2 (T2-1 and T2-2).

The communication processing unit 11 monitors and analyzes the packets transmitted among the interfaces 12 for each session and updates the content of the session management table T1 and the route management tables T2 (T2-1 and T2-2).

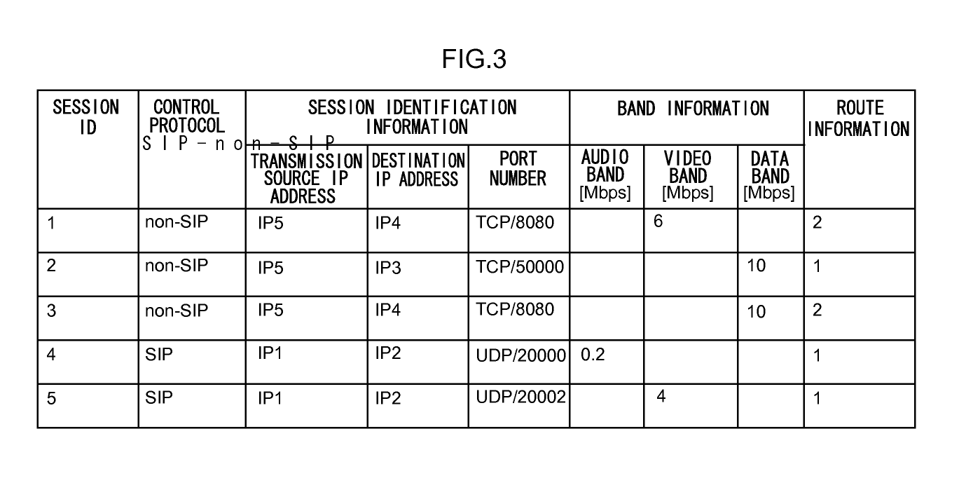

FIG. 3 is a diagram illustrating an example of the structure of the session management table T1.

The session management table T1 includes information about a session ID, a control protocol, a session identification information (a transmission source IP address, a destination IP address, and a port number), a band information (an audio band, a video band, and a data band), and a route information which are set for each session.

The ‘session ID’ indicates an identifier which is allocated to the session by the communication processing unit 11. In this embodiment, it is assumed that the communication processing unit 11 gives numbers (1, 2, 3, . . . ) which are consecutive in chronological order to each session.

The ‘control protocol’ item indicates whether the session is managed by the SIP (whether call control is performed by the SIP server 40 in the session). Hereinafter, the session managed by the SIP is referred to as an ‘SIP managed session’. In addition, hereinafter, the session which is not managed by the SIP is referred to as a ‘non-SIP managed session’. In the session management table T1, it is assumed that, ‘SIP’ is set to the control protocol item related to the SIP managed session. In addition, in the session management table T1, it is assumed that ‘non-SIP’ is set to the control protocol item related to the non-SIP managed session.

The ‘session identification information’ item indicates information required for the communication processing unit 11 to identify the packet related to the session. In the session management table T1 according to this embodiment, as illustrated in FIG. 3, it is assumed that the transmission source IP address, the destination IP address, and the port number (it is assumed that a transmission source port number and a transmission destination port number are identical to each other) are registered as the session identification information. Hereinafter, for simplicity of explanation, it is assumed that the IP addresses of the terminals 20-1 to 20-4 are represented by IP1 to IP4, respectively. In addition, it is assumed that the IP address of the content distribution server 50 is represented by IP5.

The ‘band information’ item indicates the band (the unit is [Mbps]) used by the session for each type of data. In this embodiment, it is assumed that the band information item is classified into three items, that is, an audio band, a video band, and a data band. A method of classifying the band information is not particularly limited. In particular, only the sum of the bands may be represented, without classifying the band information item.

The ‘route information’ item indicates the route corresponding to the SBC 10 through which media data related to the session is transmitted. In the communication processing unit 11, a route ID is allocated to each route. In this embodiment, it is assumed that the route ID of the route R1 is ‘1’ and the route ID of the route R2 is ‘2’.

The route management table T2 is generated for each route from the SBC 10 by the communication processing unit 11. In this embodiment, route management tables T2-1 and T2-2 are generated for the routes R1 and R2, respectively. In other words, each route management table T2 is information (row) corresponding to the route which is extracted from the information items of the session management table T1.

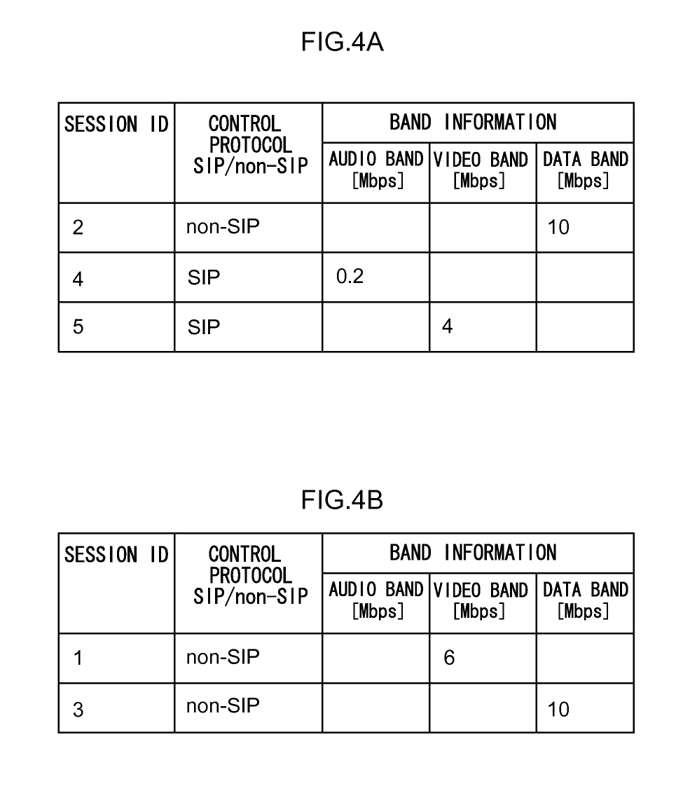

FIGS. 4A and 4B are diagrams illustrating examples of the structure of the route management table T2. FIG. 4A illustrates an example of the structure of the route management table T2-1. FIG. 4B illustrates an example of the structure of the route management table T2-2.

As illustrated in FIGS. 4A and 4B, the route management table T2 includes information about a ‘session ID’, a ‘control protocol’, and a ‘band information’ related to the corresponding route. Since these items are the same as those in the session management table T1, the detailed description thereof will be omitted.

In this embodiment, for simplicity of explanation, it is assumed that the communication processing unit 11 generates the route management table T2 different from the session management table T1. However, when information (information about the ‘session ID’, the ‘control protocol’, and the ‘band information’) about each route is managed, the separate route management table T2 is not necessarily generated.

Next, a routing process and a process of updating each table which are performed by the communication processing unit 11 will be described.

As described above, the communication processing unit 11 determines a routing destination (a route which is designated as the next hop) related to each session flowing through the SBC 10. The communication processing unit 11 checks the route (next hop) to the destination of the packets related to the session for each session. When plural routes to the destination are detected, the communication processing unit 11 determines any one of the routes to be the routing destination related to the session. When there is only one route to the destination related to the session, the communication processing unit 11 determines the route to be the routing destination of the route. A method of detecting the route (the next hop) to the destination of the packets related to the session in the communication processing unit 11 is not particularly limited. However, for example, the communication processing unit 11 may calculate the route based on the content of a routing table (for example, the same layer 3 routing table as that generated by a router) (not shown) stored therein. In this embodiment, the SBC 10 corresponds to the function of a router or the layer 3 switch which performs a layer 3 routing process and selects the route of the packets related to each session using the layer 3 (IP address) (routing process). However, the SBC 10 may be configured so as to select the route using only a switching process in the layer 2 (MAC address).

For the SIP managed session, when the routing destination is determined from plural route candidates, the communication processing unit 11 checks the state of the non-SIP managed session flowing through each route and sets any one of the routes as the routing destination of the session based on the check result. Specifically, it is assumed that the communication processing unit 11 according to this embodiment determines the route with the smallest number of non-SIP managed sessions to be the routing destination of a new SIP managed session.

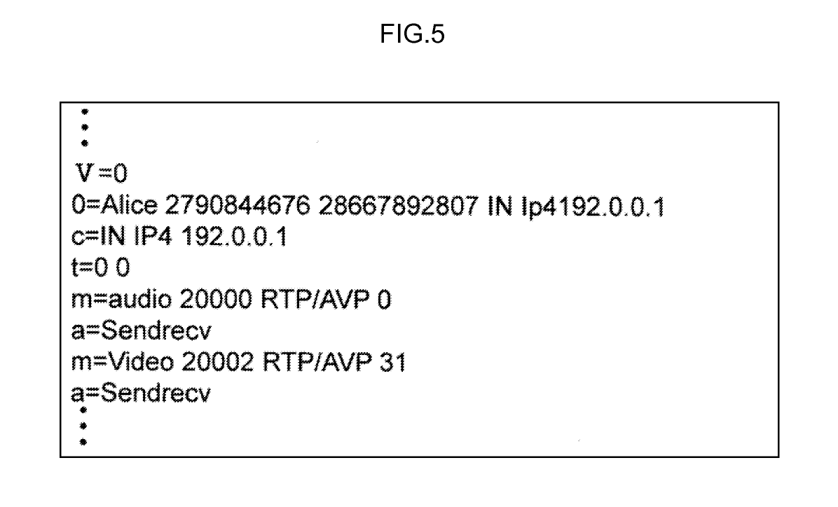

For example, the communication processing unit 11 monitors the packets of an SIP message (call control signal) flowing through each interface 12 to detect and manage the SIP managed session. For example, the communication processing unit 11 analyzes the header information of a packet including an SIP INVITE message to detect the generation of the SIP managed session. For example, when receiving an INVITE message including the header information (only a portion which is described based on the SDP is extracted) illustrated in FIG. 5, the communication processing unit 11 can detect the generation of the SIP managed session with reference to the content of a media described portion (a portion starting with ‘m=’). For example, in FIG. 5, ‘m=audio 20000 RTP/AVP 0’ and ‘m=Video 20002 RTP/AVP 31’ indicate that the session (SIP managed session) of media data related to audio is generated at port number 20000 and the session (SIP managed session) of media data related to video is generated at port number 20002, respectively. The communication processing unit 11 can acquire identification information (to know, for example, the IP addresses of the transmission source and the destination) other than the port number related to the SIP managed session whose generation has been detected, with reference to another header information item (for example, To header or From header) of the INVITE message. As such, the communication processing unit 11 monitors the content of the SIP message to know the generation of the SIP managed session and information (for example, the port number and the IP addresses of the transmission source and the destination) for identifying the SIP managed session. When only the URLs or the transmission source and the transmission destination or a host name is described in the INVITE message, but the IP address is not described in the INVITE message, the communication processing unit 11 may inquire the IP address of a server (for example, another SIP server or a DNS server) which can perform name analysis to acquire the IP address.

For example, the communication processing unit 11 monitors the packets related to session control other than the SIP which flows through each interface 12 to detect and manage the non-SIP managed session. For example, the communication processing unit 11 monitors a control packet (for example, a Syn packet and an ACK packet which responds to the Syn packet) related to the start of a TCP or UDP session to know the generation of the non-SIP managed session and session identification information (the port number and the IP addresses of the transmission source and the destination) for identifying the non-SIP managed session.

When the routing destination is determined from plural route candidates, the communication processing unit 11 checks the state of the non-SIP managed session flowing through each route and sets any one of the routes as the routing destination of the session based on the check result. Specifically, as described above, it is assumed that the communication processing unit 11 according to this embodiment determines the route with the smallest number of non-SIP managed sessions to be the routing destination of a new SIP managed session.

The communication processing unit 11 applies content corresponding to the determined routing destination to the session management table T1 and the route management table T2 (a table corresponding to the determined routing destination route).

The communication processing unit 11 updates the band information of each session based on the reception conditions of the packet related to each session which is managed by the session management table T1 and the route management tables T2-1 and T2-2. An algorithm which is used by the communication processing unit 11 to calculate the band information of each session is not particularly limited. However, for example, the communication processing unit 11 may calculate the band information based on the amount of data or the number of packets transmitted per unit time within a predetermined period of time, or it may calculate the band information based on the amount of data or the number of packets transmitted until now from the generation of the session.

A method of determining the media type (for example, any one of audio, video, and data) of the non-SIP managed session in the communication processing unit 11 is not particularly limited. However, for example, the media type may be determined based on the port number. When the band information is not managed by the session management table T1 and the route management tables T2-1 and T2-2 or when the media type is not managed by the band information, the communication processing unit 11 does not need to determine the media type related to each session.

A method of determining the routing destination related to the non-SIP managed session performed by the communication processing unit 11 is not particularly limited. However, the existing various load distribution algorithms may be used. In addition, a method of determining the routing destination of the packets which do not flow on the continuously established sessions, such as various control packets (including an SIP signal), in the communication processing unit 11 is not particularly limited. However, the existing various load distribution algorithms may be used.

In this embodiment, for simplicity of explanation, only the structure in which the session related to the route (the route R1 or the route R2) from the SBC 10 to the switch 30-1 or the switch 30-2 is processed has been described. However, in practice, the same process may be performed for the sessions in both directions (for example, a direction from the SBC 10 to the network N1 or the network N2).

### (A-2) Operation of Embodiment

Next, the operation of the communication system 1 having the above-mentioned structure according to this embodiment will be described.

### (A-2-1) Operation when Non-Sip Managed Session is Generated

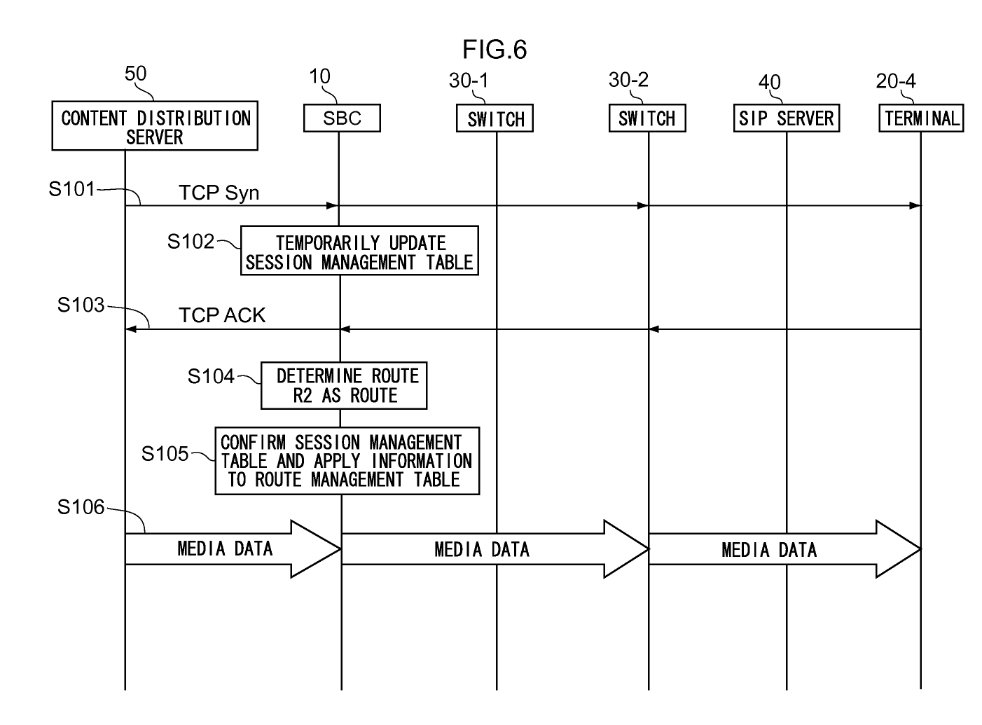

First, the operation of the communication system 1 when a new non-SIP managed session is generated will be described with reference to the sequence diagram illustrated in FIG. 6.

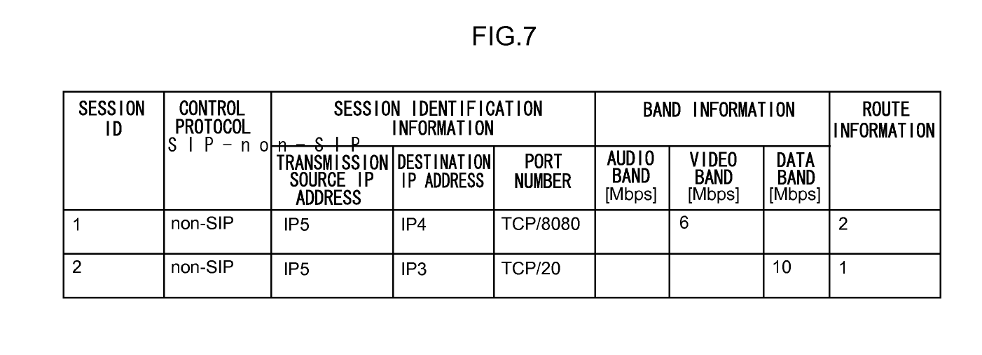

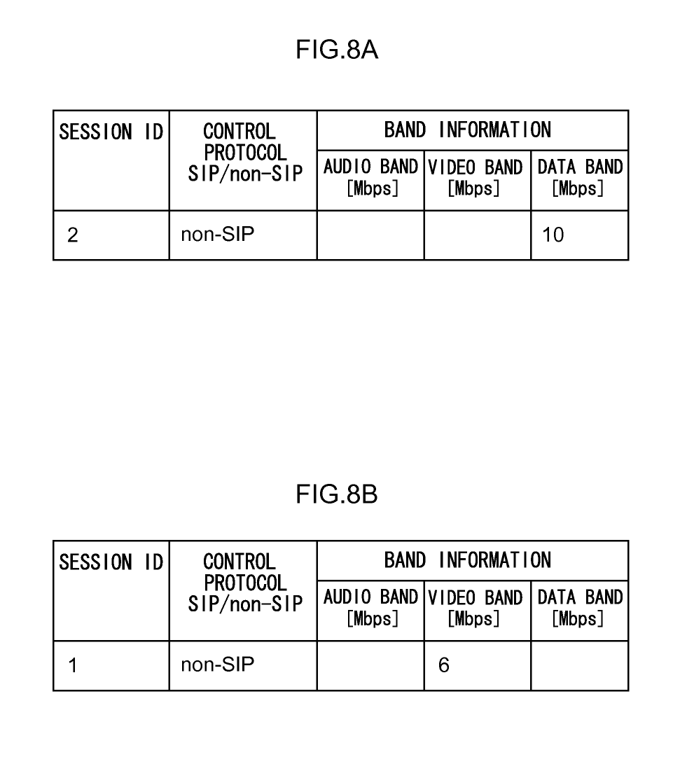

Here, it is assumed that the route management table T2 and the route management tables T2-1 and T2-2 of the SBC 10 are in the states illustrated in FIG. 7 and FIGS. 8A and 8B as the initial state of the process illustrated in the sequence diagram of FIG. 6.

It is assumed that the terminal 20-4 requests the content distribution server 50 to download content data using HTTP. It is assumed that the content distribution server 50 transmits a TCP Syn packet for starting the session in which data is distributed using HTTP (TCP/8080) to the terminal 20-4. The TCP Syn packet is supplied to the SBC 10 (communication processing unit 11). Then, the communication processing unit 11 transmits the TCP Syn packet to the switch 30-2 (route R2) such that it can reach the IP address (IP4, the terminal 20-4) of the destination. Then, the TCP Syn packet reaches the terminal 20-4 through the switch 30-2 (S101).

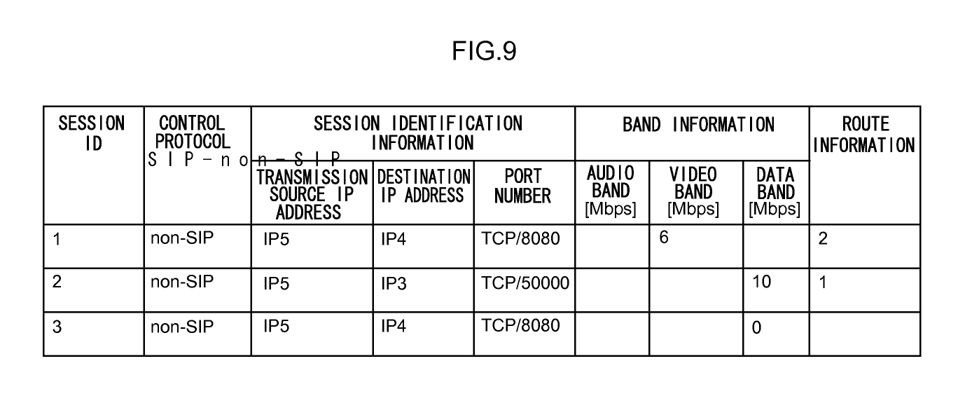

The communication processing unit 11 temporarily updates the session management table T1 based on the content of the transmitted TCP Syn packet (S102). In this case, the communication processing unit 11 sets ‘3’ as the session ID related to the TCP Syn packet and temporarily updates the session management table T1. As a result, the content of the session management table T1 is temporarily updated as illustrated in FIG. 9. In this case, the communication processing unit 11 sets 0 as the initial value of the band information with the newly added session ID ‘3’ to the corresponding type item. Specifically, the communication processing unit 11 sets 0 to the data band item among band information items. At that time, the route information with the session ID ‘3’ is unset (blank).

Then, the terminal 20-4 transmits a TCP ACK packet for responding to the received TCP Syn packet to the content distribution server 50. When the TCP ACK packet is supplied to the SBC 10, the communication processing unit 11 transmits the TCP ACK packet to the content distribution server 50 (S103).

Then, the communication processing unit 11 determines the route through which the packet related to the session is transmitted, with the passage of the TCP ACK packet related to the session ID ‘3’ (S104). However, since only the route R2 reaches the terminal 20-4 (IP4) as viewed from the SBC 10, the communication processing unit 11 determines the route R2 to be the route corresponding to the session ID ‘3’.

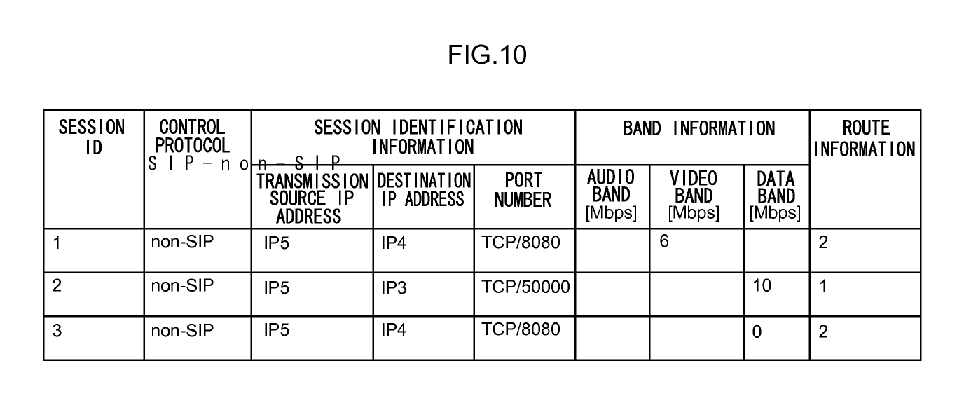

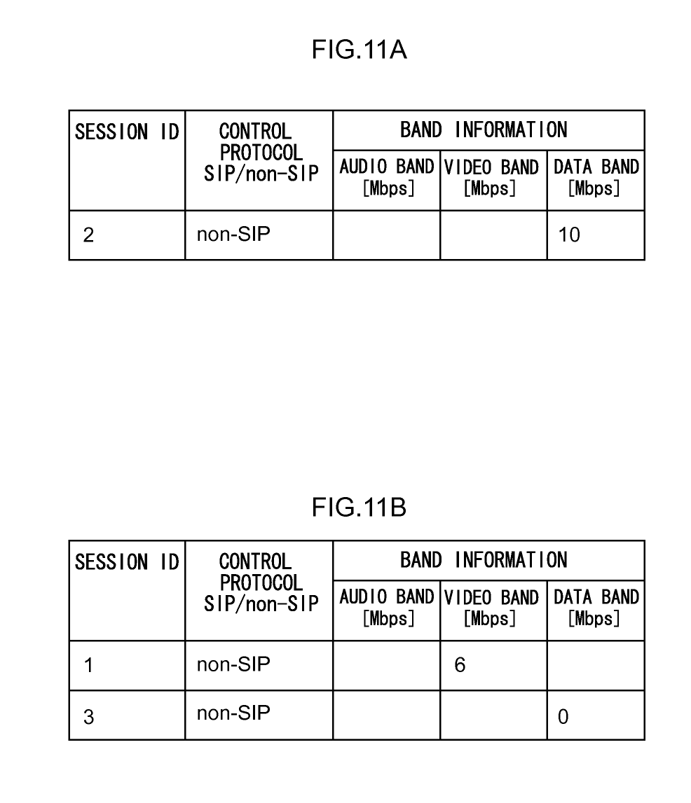

Then, the communication processing unit 11 sets the route to the temporarily updated session management table T1 (sets the route R2 to the route information of the session ID ‘3’), confirms the setting, and adds information about the session ID ‘3’ to the route management table T2-2 corresponding to the route R2, thereby updating the tables (S105). As a result, the content of the session management table T1 and the route management table T2 (T2-1 and T2-2) is updated as illustrated in FIG. 10 and FIGS. 11A and 11B. In FIGS. 11A and 11B, FIG. 11A illustrates the content of the route management table T2-1 at that time and FIG. 11B illustrates the content of the route management table T2-2 at that time.

Then, the content distribution server 50 starts the transmission of content data to the terminal 20-4. Then, the SBC 10 transmits the packets (packets related to the session ID ‘3’) of the content data transmitted from the content distribution server 50 to the terminal 20-4 to the route R2 (switch 30-2) based on the session management table T1 (S106). Then, while the packets are being transmitted, the communication processing unit 11 measures the band related to the session ID ‘3’. Then, the communication processing unit 11 updates the band information of the session management table T1 and the route management table T2-2 based on the measurement result of the band.

### (A-2-2) Operation when SIP Managed Session is Generated

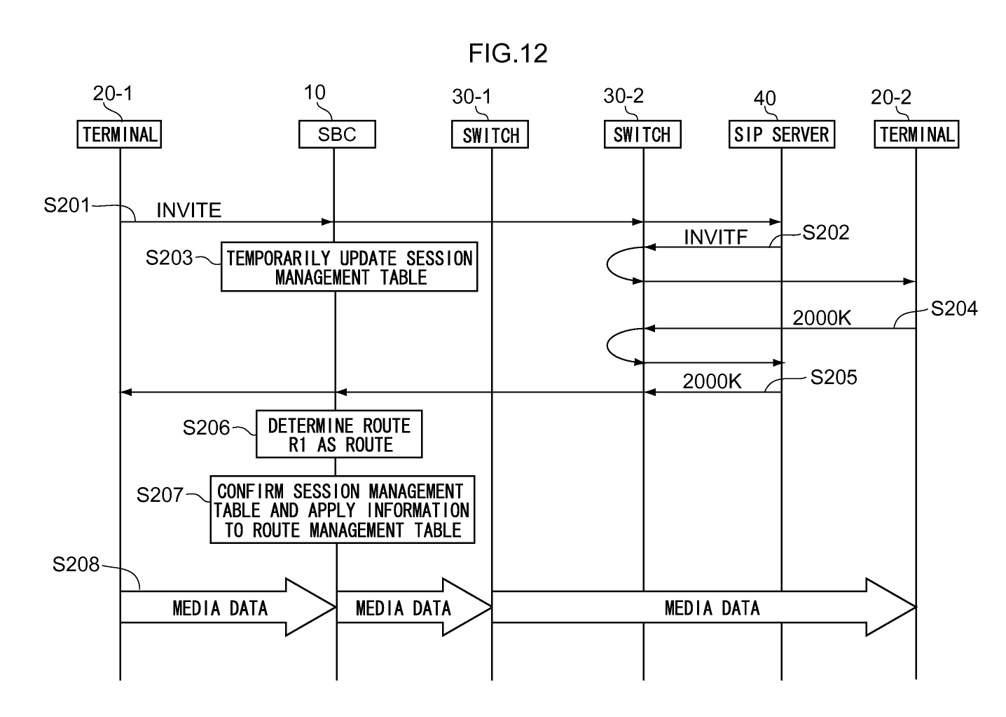

Next, the operation of the communication system 1 when a new SIP managed session is generated will be described with reference to the sequence diagram illustrated in FIG. 12.

Here, it is assumed that the route management table T2 and the route management tables T2-1 and T2-2 of the SBC 10 are in the states illustrated in FIG. 10 and FIGS. 11A and 11B as the initial state of the process illustrated in the sequence diagram of FIG. 12.

Here, it is assumed that the terminal 20-1 transmits an INVITE message (SIP message) for requesting a video call (audio and video sessions) with the terminal 20-2 to the SIP server 40. It is assumed that the INVITE message reaches the SIP server 40 through the SBC 10 and the switch 30-2 (S201).

In this case, the INVITE message is referred to by the communication processing unit 11 when it passes through the SBC 10. The communication processing unit 11 temporarily updates the session management table T1 based on the INVITE message (S203).

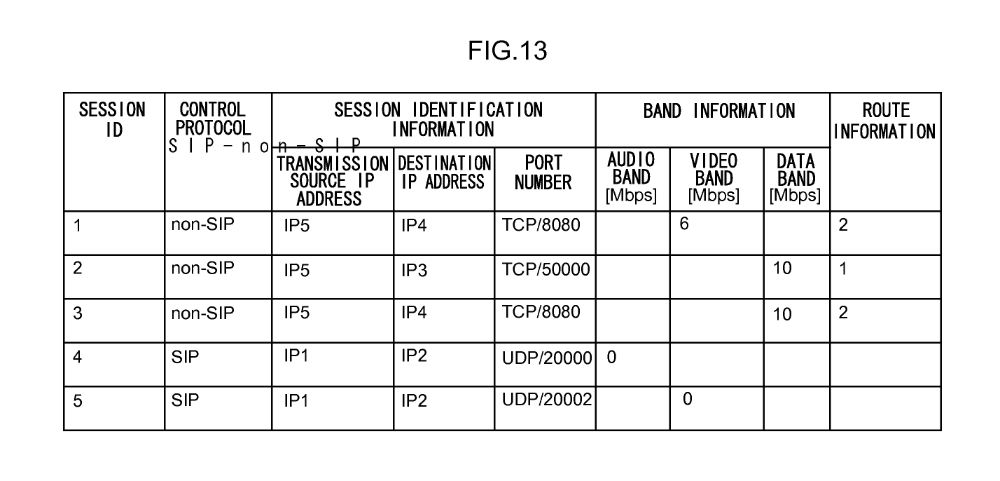

In this case, the content illustrated in FIG. 5 (content described by SDP) is described in the header of the INVITE message. The communication processing unit 11 knows two sessions (the session of media data related to audio and the session of media data related to video) related to the INVITE message, based on, for example, ‘m=audio 20000 RTP/AVP 0’ and ‘m=Video 20002 RTP/AVP 31’ in the content. In addition, it is assumed that the communication processing unit 11 gives a session ID ‘4’ and a session ID ‘5’ to the session related to audio and the session related to video, respectively. In this case, the content of the temporarily updated session management table T1 is as illustrated in FIG. 13.

The SIP server 40 which has received the INVITE message from the terminal 20-1 processes the INVITE message. The SIP server 40 generates an INVITE message for making a call to the terminal 20-2 based on a request from the terminal 20-1 and transmits the INVITE message to the terminal 20-2. The INVITE message is supplied to the terminal 20-2 (S202).

Then, the terminal 20-2 is assumed to generate an SIP message ‘200 OK’ for responding to the call based on the supplied INVITE message and transmit the SIP message to the SIP server 40 (S204).

Then, the SIP server 40 processes the supplied SIP message ‘200 OK’. The SIP server 40 generates an SIP message ‘200 OK’ for responding to the request from the terminal 20-1, based on a response (message ‘200 OK’) from the terminal 20-2 and transmits the SIP message to the terminal 20-1. Then, the SIP message ‘200 OK’ is supplied to the terminal 20-1 through the switch 30-2 and the SBC 10 (S205).

Then, the communication processing unit 11 of the SBC 10 determines the route through which the packets related to the session are transmitted, with the passage of the SIP message ‘200 OK’ related to the session ID ‘4’ and the session ID ‘5’ (S206). In this case, the communication processing unit 11 detects the route R1 and the route R2 as the route to the terminal 20-2. Then, the communication processing unit 11 selects the route with the smaller number of non-SIP managed sessions (the sessions in which the control protocol is non-SIP), with reference to the route management tables T2-1 and T2-2 (in the states illustrated in FIGS. 11A and 11B). Here, the communication processing unit 11 selects the route R1 with the smaller number of non-SIP managed sessions.

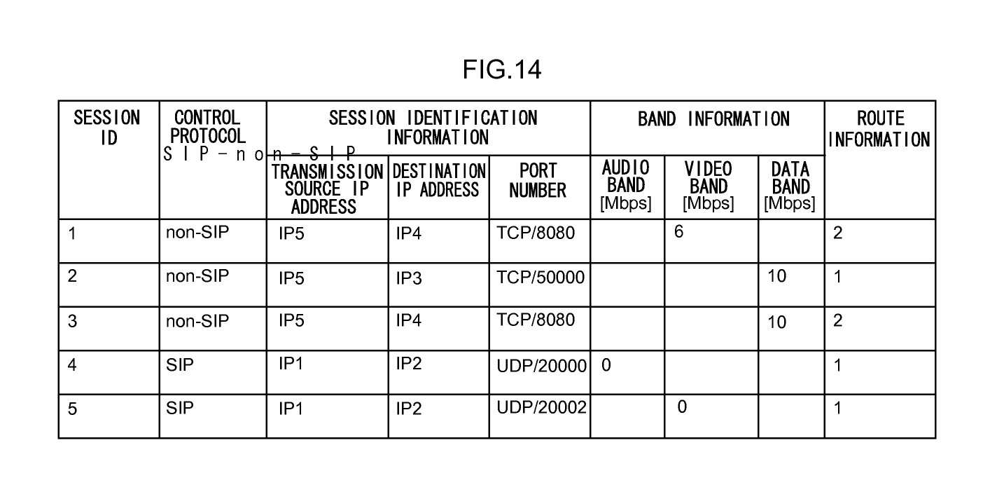

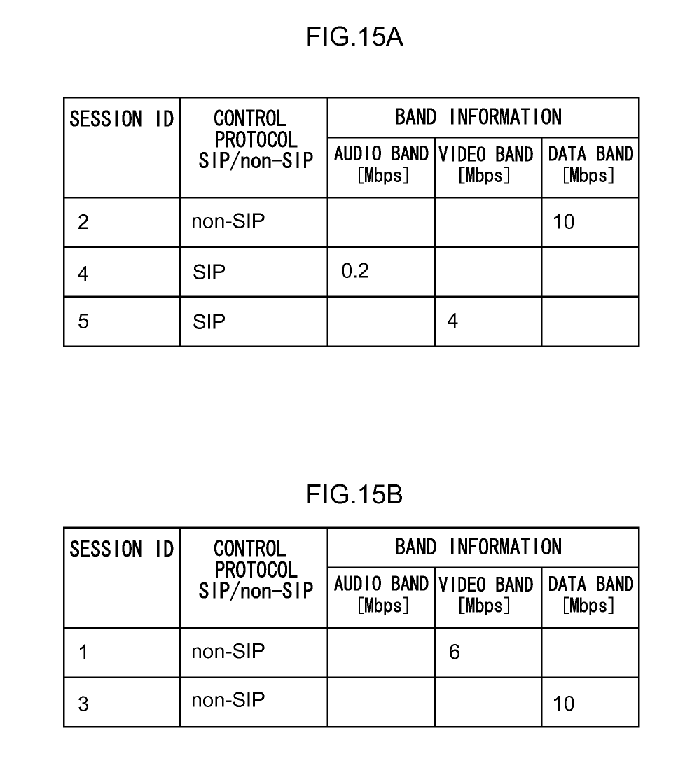

Then, the communication processing unit 11 sets the route to the temporarily updated session management table T1 (sets the route R1 to the route information of the session ID ‘4’ and the session ID ‘5’), confirms the setting, and adds information about the session ID ‘3’ to the route management table T2-1 corresponding to the route R1, thereby updating the tables (S207). As a result, the content of the session management table T1 and the route management table T2 (T2-1 and T2-2) is updated as illustrated in FIG. 14 and FIGS. 15A and 15B. In FIGS. 15A and 15B, FIG. 15A illustrates the content of the route management table T2-1 at that time and FIG. 15B illustrates the content of the route management table T2-2 at that time.

Then, the terminal 20-1 starts the transmission of audio data and video data to the terminal 20-2. Then, the SBC 10 transmits the packets (packets relates to the session ID ‘3’ and the session ID ‘4’) transmitted from the terminal 20-1 to the terminal 20-2 to the route R1 (switch 30-1) based on the session management table T1 (S207). While the packets are being transmitted, the communication processing unit 11 measures the band related to the session ID ‘3’ and the session ID ‘4’. Then, the communication processing unit 11 updates the band information of the session management table T1 and the route management table T2-1 based on the measurement result of the band.

### (A-3) Effect of Embodiment

According to this embodiment, the following effect can be obtained.

When a routing destination is determined from plural route candidates for a newly generated SIP managed session, the SBC 10 (communication processing unit 11) of the communication system 1 determines the route with the smallest number of non-SIP managed sessions to be the routing destination of the new SIP managed session. As described above, for the session which is not managed by the SIP (particularly, the session related to the video or data file which is established for a long time), the number of bands used are likely to increase in a burst manner. Therefore, the SBC 10 (communication processing unit 11) determines the route with the smallest number of non-SIP managed sessions to be the routing destination for the SIP managed session, thereby preventing deterioration in the communication quality of the SIP managed session (for example, a reduction in delay or fluctuation).

In the communication system 1, as described above, even when the SIP managed session and the non-SIP managed session are mixed in the same band (communication path), it is possible to prevent deterioration in the communication quality of the SIP managed session and thus effectively use the communication band.

### (C) Other Embodiments

The invention is not limited to the above-described embodiment, but the following modifications of the invention can be made.

(C-1) In the above-described embodiment, the communication device according to the invention is applied to the SBC. However, the device to which the communication device according to the invention is applied is not limited thereto. For example, the communication device according to the invention may be applied to a gateway device, such as a router, a layer 3 switch, or a layer 4 switch (load balancer).

(C-2) In the communication system 1 according to the above-described embodiment, the SBC 10 autonomously determines the route related to each session based on information which can be acquired by the SBC 10. However, a separate control device may be provided and the route may be determined by the control device. For example, when there are plural SBCs 10 and there are plural branches where the route needs to be determined, the control device may detect the path with the smallest number of non-SIP managed sessions from end to end and determine the path related to each SBC 10.

(C-3) When the route of the SIP managed session is determined, the SBC 10 (communication processing unit 11) according to the above-described embodiment considers the number of non-SIP managed sessions for each route. However, the SBC 10 may consider the band information of each route. For example, in the determination of the route of the SIP managed session, when there are plural routes with the same number of non-SIP managed sessions, the SBC 10 may determine the route with the smallest number of bands used (the sum of the values indicated in the band information) to be the route of the SIP managed session.

(C-4) In the above-described embodiment, the SBC 10 (communication processing unit 11) processes the packets related to the SIP managed session in which a call is controlled by the SIP. However, the SBC 10 may process the session in which a call is controlled by other call control protocols (for example, H.323).

The entire disclosure of Japanese Patent Application No. 2012-201671 is incorporated herein by reference in its entirety.

All of the documents, patent applications, and technical standards cited in this specification are herein incorporated by reference to the same extent as if each individual document, patent application and technical standard were specifically and individually indicated to be incorporated by reference.

1. A communication device that relays data among a plurality of networks, comprising:
a data processing unit for transmitting received data to a route to a destination of the data;
a session management unit for managing data flowing through the communication device in a session unit and classifying managed sessions into a management session which is managed by a call control device using a call control protocol and a non-management session which is not managed by the call control device using the call control protocol; and
a route determining unit for determining a route related to the management session which is managed by the session management unit based on conditions of the non-management session passing through a route to a destination of the management session,
wherein the data processing unit outputs data related to the management session to the route determined by the route determining unit.

2. The communication device according to claim 1, wherein the route determining unit considers the number of non-management sessions passing through the route to the destination of the management session when determining the route related to the management session which is managed by the session management unit.

3. The communication device according to claim 2, wherein the route determining unit determines the route through which the smallest number of non-management sessions pass among the routes to the destination of the management session managed by the session management unit to be the route related to the management session.

4. A non-transitory computer-readable storage medium storing a communication program that causes a computer provided in a communication device which relays data among a plurality of networks to function as:
a data processing unit for transmitting received data to a route to a destination of the data;
a session management unit for managing data flowing through the communication device in a session unit and classifying managed sessions into a management session which is managed by a call control device using a call control protocol and a non-management session which is not managed by the call control device using the call control protocol; and
a route determining unit for determining a route related to the management session which is managed by the session management unit based on conditions of the non-management session passing through a route to a destination of the management session,
wherein the data processing unit outputs data related to the management session to the route determined by the route determining unit.

5. A communication method that causes a computer provided in a communication device which relays data among a plurality of networks to perform:
transmitting received data to a route to a destination of the data;
managing data flowing through the communication device in a session unit and classifying managed sessions into a management session which is managed by a call control device using a call control protocol and a non-management session which is not managed by the call control device using the call control protocol; and
determining a route related to the management session based on conditions of the non-management session passing through a route to a destination of the management session,
wherein, in the transmission of the received data, data related to the management session is transmitted to the determined route.

6. A communication system comprising:
the communication device according to claim 1 that relays the data between the plurality of networks.

7. The communication method according to claim 5, wherein determining a route related to the management session comprises considering the number of non-management sessions passing through the route to the destination of the management session when determining the route related to the management session.

8. The communication method according to claim 7, wherein determining a route related to the management session comprises determining the route through which the smallest number of non-management sessions pass among the routes to the destination of the management session to be the route related to the management session.
